(19) United States
(12) Patent Application Publication
(10) Pub. No.: US 2011/0133670 A1
(43) Pub. Date: Jun. 9, 2011

(54) Street lamp capable of adjusting illuminating range thereof and having LEDs as light source

(75) Inventors: Ming-Hai Lee, Hsinchu City (TW); Chin-Ju Wu, Hsinchu City (TW); Tung-Huang Lu, Hsinchu City (TW)

(73) Assignee: QBAS TECH. CO., LTD., Hsinchu City (TW)

(21) Appl. No.: 12/957,031

(22) Filed: Nov. 30, 2010

(30) Foreign Application Priority Data
Dec. 4, 2009 (TW) 098222720

(51) Int. Cl. H05B 37/02; F21S 4/00

(52) U.S. Cl. 315/294; 362/249.02

(57) ABSTRACT

A street lamp capable of adjusting illuminating range thereof and having LEDs as its light source is provided. The street lamp comprises: a main supporting member; a substrate, one end of the substrate being pivotally fixed to the main supporting member by a first fastening member, and an LED light source being provided on the surface opposite to the main supporting member; and an adjusting member provided between the main supporting member and the substrate, one end of the adjusting member being pivotally fixed to the main supporting member by a second fastening member, wherein a fixing member for adjusting the angle of the substrate to adjust the illuminating angle is provided between the substrate and the adjusting member when the first fastening member and the second fastening member are pivotally movable.

### TECHNICAL FIELD

The present invention relates to a street lamp capable of adjusting illuminating range thereof and having LEDs as its light source.

### BACKGROUND

While the light emitting diode (referred to as “LED” hereinafter) has been developing since 1950's, it is commonly used in many fields. LEDs convert electrical energy into light energy. Firstly, the fifth group elements (such as nitrogen (N), phosphorous (P), and arsenic (As)) and the third group elements (such as aluminum (Al), gallium (Ga), and indium (In)) suffer the process of liquid phase epitaxy (referred to as “LPE” hereinafter) or vapor phase epitaxy (referred to as “VPE” hereinafter) to produce III-V compound semiconductor (such as gallium phosphide (GaP) or gallium arsenide (GaAs)) to form a substrate. Then it applies voltage within a positive electrode and a negative electrode of the substrate. Thus an electrical current passes through the substrate to make electrons and holes combine with each other. The electrons therefore fall into the region with low valance and release the excess energy in a form of light. The LEDs emit light thereby. The LEDs use low voltage power instead of high voltage power so the power consumption is 80% less as compared with the incandescent with the same luminance. The response time of the LEDs is more than 1000 times faster than that of the incandescent lamps. There is no detrimental metal (such as mercury) in the LEDs so that the environment contamination is reduced. Light with various colors may be emitted by changing the chemical material in the substrate. The LEDs can emit light without tungsten filaments so the heat dissipated by the LEDs is less. The LEDs can be touched directly by hands due to the low temperature itself. The LEDs are safer than other lamps.

The LEDs are classified into various types. The LEDs are mostly used for indicating light sources of appliances, interior displays, large billboards, traffic signs. In recent years, the LEDs also become a type of light source for a street lamp. However, the illuminating range for the LED street lamp is limited by the fact that the light direction thereof is perpendicular to the surface of LED light source. Thus, the adjustment of the illuminating range is needed. The conventional manner for adjusting the illuminating angle is achieved by a lens body 502 connected with a frame body 503 as shown in FIG. 5. Referring to FIG. 5, a conventional LED street lamp 500 comprises a single LED light source 501 or a plurality of LED light sources 501, wherein the latter is shown in FIG. 5. The light radiated from the LED light sources 501 is scattered to a broader region by means of the radius of curvature of the lens body 502. The radius of curvature of the lens body 502 is alternative according to the illuminating range needed. The conventional LED street lamp 500 should use the lens body with different radius of curvature for different situation so as to project the light with different illuminating angles. A lens body 502 may not be suitable for different illuminating ranges in desire. The manufacture cost thus increases due to not only the need of the lens body 502 but also the need for various different contour of lens body 502. Furthermore, the light strength decreases due to the fact that the light is scattered by the radius of curvature of the lens body 502. If a particular regions need to be illuminated more, the number of the LED light sources 501 or the number of the LED street lamps must be increased. Thus since the undesired area is also illuminated, the light efficiency also worse.

### SUMMARY

A street lamp capable of adjusting illuminating range thereof and having LEDs as its light source is provided according to the present invention. The street lamp includes a main supporting member; a substrate, one end of the substrate being pivotally fixed to the main supporting member by a first fastening member, and an LED light source is provided on the surface opposite to the main supporting member; an adjusting member provided between the main supporting member and the substrate, one end of the adjusting member being pivotally fixed to the main supporting member by a second fastening member. A fixing member for adjusting the angle of the substrate to adjust the illuminating range is provided between the substrate and the adjusting member. Only when the first fastening member and the second fastening member are pivotally movable the substrate may be adjusted. After adjusting the illuminating angle, the substrate, secured by the friction between the fixing member and the adjusting member, is fixed by fixing the first fastening member and the second fastening member. Moreover, an enhancing member is included. Each end of the enhancing member is provided and secured to the main supporting member and the adjusting member respectively.

The street lamp according to an embodiment of the present invention may adjust the position of the adjusting member relative to the fixing member if necessary. The illuminating range is adjusted thereafter. In this manner, there is no need for any installation of the lens body, and the adjustment of illuminating range is achieved by mechanical allocation. The position of the substrate is mechanically adjusted without the necessity of adding any other light source when a specific area is in need to be illuminated. Additionally, different LED light source, such as color LED, may be used to accomplish different light effect.

### BRIEF DESCRIPTION OF THE DRAWINGS

FIG. 1 is a perspective back view of a street lamp capable of adjusting illuminating range thereof and having LEDs as its light source according to an embodiment of the present invention.

FIG. 2 is a perspective back view of a street lamp capable of adjusting illuminating range thereof and having LEDs as its light source according to another embodiment of the present invention.

FIG. 3 is a partial view of a street lamp capable of adjusting illuminating range thereof and having LEDs as its light source according to an embodiment of the present invention.

FIG. 4a is a front view of a street lamp capable of adjusting illuminating range thereof and having LEDs as its light source according to an embodiment of the present invention.

FIG. 4b is a front view of a street lamp capable of adjusting illuminating range thereof and having LEDs as its light source according to another embodiment of the present invention.

FIG. 5 is a perspective view of a street lamp according to a conventional street lamp.

### DETAILED DESCRIPTION

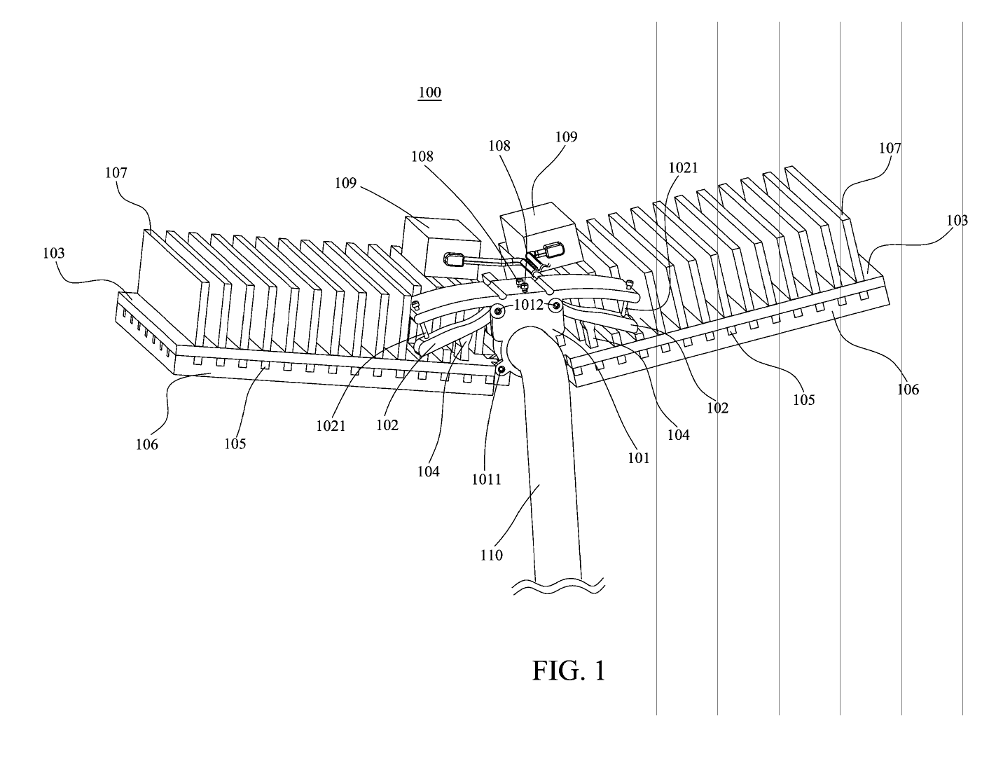

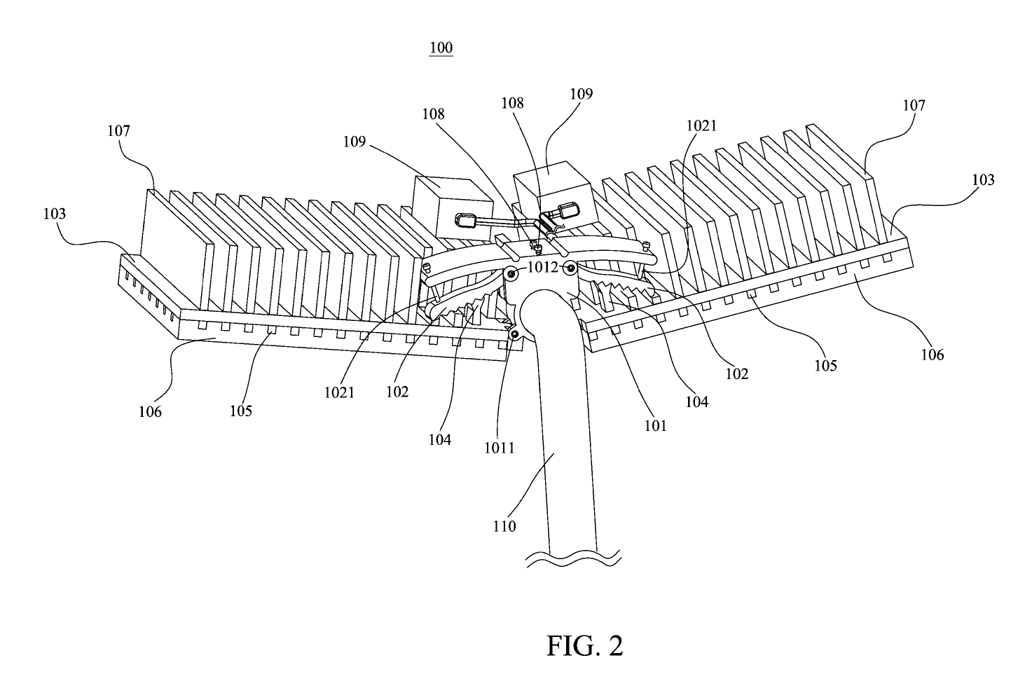

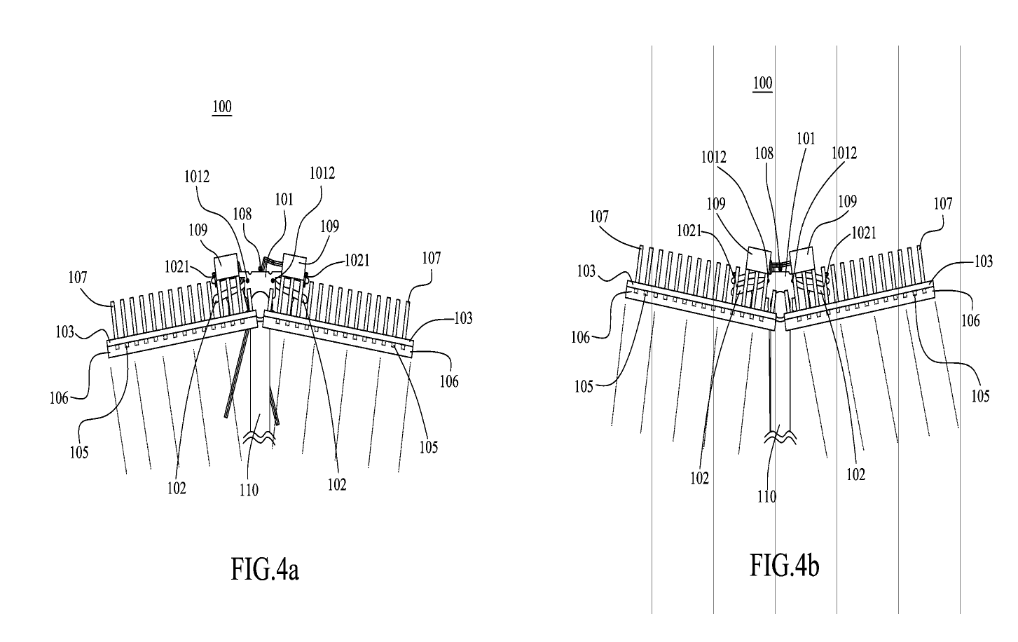

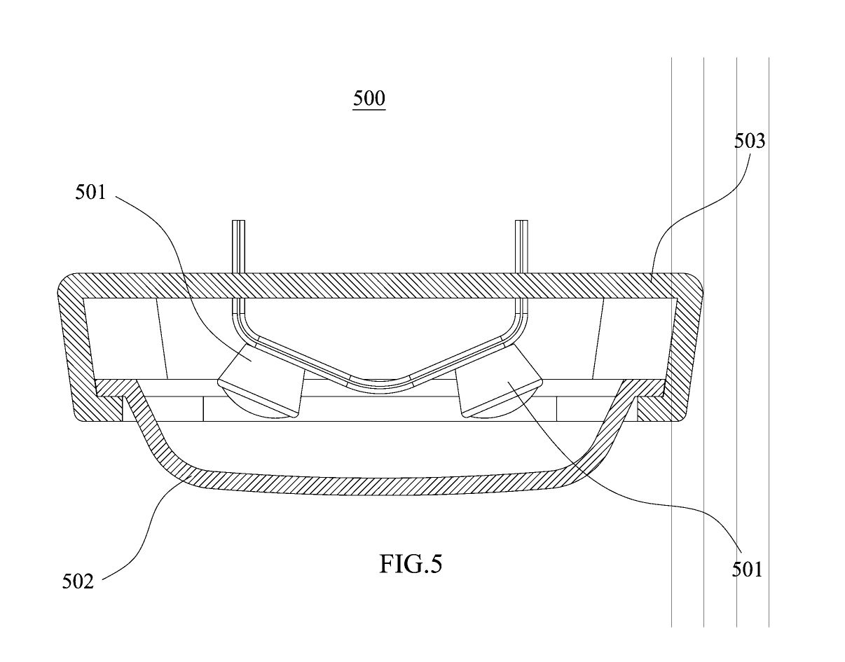

Referring to FIG. 1, FIG. 4a and FIG. 4b, the street lamp capable of adjusting illuminating range thereof and having LEDs as its light source is described. FIG. 1 is a perspective back view of a street lamp capable of adjusting illuminating range thereof and having LEDs as its light source according to an embodiment of the present invention. FIG. 4a is a front view of the street lamp shown in FIG. 1. FIG. 4b is also a front view of the street lamp shown in FIG. 1. The difference between FIG. 4a and FIG. 4b is in their different illuminating angles. As shown in FIG. 1, The street lamp 100 capable of adjusting illuminating range thereof and having LEDs as its light source (briefed as street lamp 100 hereinafter) includes a main supporting member 101; a substrate 103, one end of the substrate 103 being pivotally fixed to the main supporting member 101 by a first fastening member 1011, and an LED light source 105 is provided on the surface opposite to the main supporting member 101; an adjusting member 102 provided between the main supporting member 101 and the substrate 103, one end of the adjusting member 102 being pivotally fixed to the main supporting member 101 by a second fastening member 1012. A fixing member 104 for adjusting the angle of the substrate 103 to adjust the illuminating range is provided between the substrate 103 and the adjusting member 102. Only when the first fastening member 1011 and the second fastening member 1012 are pivotally movable the substrate 103 may be adjusted. After adjusting the illuminating angle, the substrate 103, secured by the friction between the fixing member 104 and the adjusting member 102, is fixed by fixing the first fastening member 1011 and the second fastening member 1012. Moreover, an enhancing member 1021 is included. Each end of the enhancing member 1021 is provided and secured to the main supporting member 101 and the adjusting member 102 respectively. Note, only when the enhancing member 1021 and the main supporting member 101 are loosened or when the enhancing member 1021 and the adjusting member 102 are loosened, the second fastening member 1012 can be loosened in order to pivotally rotate the adjusting member 102. The main supporting member 101 is formed according to the contour of a light pole 110 to cover the light pole 110 and be affixed to the light pole 110. In addition, the street lamp 100 includes a plurality of fin plates 107 provided on the substrate 103. The fin plates 107 are used for dissipating heat generated by the LED light source 105. The street lamp 100 further includes an auxiliary fastening member 108 for securely affixing the street lamp 100 to the light pole 110. The street lamp 100 further includes a voltage adaptor 109 connected between the main supporting member 101 and an exterior power supply which is not shown in the figures. Referring to FIG. 2, in order to make the adjusting member 102 moves precisely relative to the fixing member 104, the contact surfaces of the adjusting member 102 and the fixing member 104 are provided with teeth engaged with each other. The teeth not only increase the friction between the contact surfaces but limit the relative position of the adjusting member 102 to the fixing member 104.

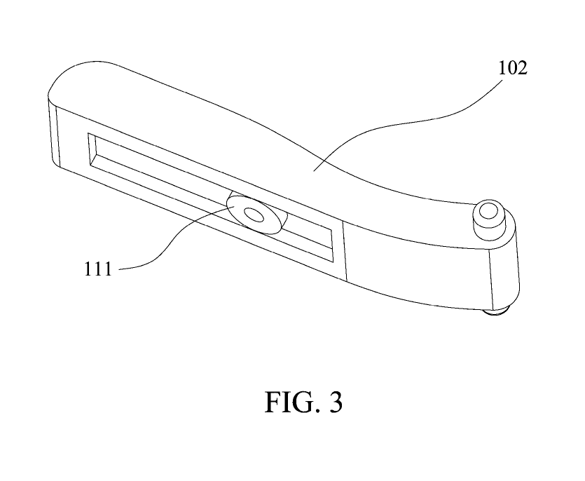

In another embodiment as referring to FIG. 3, a slot is formed to provide a contact surface between the adjusting member 102 and the fixing member 104. There provides a gasket 111 on the contact surface of the fixing member 104 to enhance the friction between the adjusting member 102 and the fixing member 104.

When the adjustment of illuminating angle is needed, it is achieved by loosening the enhancing member 1021 and the main supporting member 101, or by loosening the enhancing member 1021 and the adjusting member 102. Then, the second fastening member 1012 is loosened, so that the adjusting member 102 is movable relative to the fixing member 104. Furthermore, since the adjusting member 102 is in contact with the fixing member 104, the movement of the adjusting member 102 will drive the fixing member 104 to move upwards or downwards. Such that the fixing member 104 will drive the substrate 103 to move upwards or downwards. Thus the illuminating range is adjusted. After the desired illuminating angle of the substrate 103 is in position, it needs to tighten the enhancing member 1021 and the second fastening member 1012 so as to secure the adjusting member 102 in relation to the fixing member 104.

FIG. 4a and FIG. 4b are side views of the street lamp of the present invention, illustrating the different illuminating angles of the substrate 103 as shown marked with dotted line. It also allows a street lamp 100 with two different illuminating ranges on two sides when it needs to illuminate more in some specific area such as the corner of the street or the fence of street in mountain area.

The above embodiment is not for limiting the scope of the present invention. It should be understood for the people with an ordinary skill in the field that the variety of modification or change of the above embodiment should be in the scope of the present invention if within the spirit of following claims.

1. A street lamp capable of adjusting illuminating range thereof and having LEDs as its light source, comprising:
a main supporting member;
a substrate, one end of the substrate being pivotally fixed to the main supporting member by a first fastening member, and an LED light source being provided on the surface opposite to the main supporting member; and
an adjusting member provided between the main supporting member and the substrate, one end of the adjusting member being pivotally fixed to the main supporting member by a second fastening member,
wherein a fixing member for adjusting the angle of the substrate to adjust the illuminating range is provided between the substrate and the adjusting member when the first fastening member and the second fastening member are pivotally movable,
after the illuminating angle is adjusted, the substrate, secured by the friction between the fixing member and the adjusting member, is fixed by fixing the first fastening member and the second fastening member.

2. A street lamp as claimed in claim 1, comprising:
an enhancing member provided and secured between the main supporting member and the adjusting member.

3. A street lamp as claimed in claim 2, comprising:
a plurality of fin plates, allocated on the substrate, for dissipating the heat generated by the LED light source, and
a mask for covering the LED light source,
wherein when the enhancing member is loosened with the main supporting member or with the adjusting member, the second fastening member is loosened to pivotally move the adjusting member.

4. A street lamp as claimed in claim 1, wherein
the contact surfaces of the adjusting member and the fixing member are provided with teeth engaged to each other, so as to generate the friction.

5. A street lamp as claimed in claim 1, comprising
a slot formed to provide a contact surface between the adjusting member and the fixing member, and
a gasket provided on the contact surface of the fixing member to enhance the friction between the adjusting member and the fixing member.

6. A street lamp as claimed in claim 2, comprising
a voltage adapter, connected between the main supporting member and a power supply, for adapting the supplying voltage from the power supply to input voltage suitable for variety of LED light source.

7. A street lamp as claimed in claim 2, comprising
an auxiliary fastening member for securely affixing the street lamp to a light pole.
